(19) United States
(12) Patent Application Publication
(10) Pub. No.: US 2021/0023899 A1
(43) Pub. Date: Jan. 28, 2021

(54) Wheel Module for a Motor Vehicle

(71) Applicant: Schaeffler Technologies AG & Co. KG, Herzogenaurach (DE)

(72) Inventors: Benjamin Wuebbolt-Gorbatenko, Erlangen (DE); Simon Mersmann, Herzogenaurach (DE); Andreas Wöllner, Nürnberg (DE); Axel Hoffmann, Neustadt/Weinstraße (DE); Christian Harkort, Erlangen (DE); Manfred Kraus, Herzogenaurach (DE)

(73) Assignee: Schaeffler Technologies AG & Co. KG, Herzogenaurach (DE)

(21) Appl. No.: 16/981,450

(22) PCT Filed: Mar. 26, 2019
(86) PCT No.: PCT/DE2019/100281

§ 371 Date: Sep. 16, 2020

(30) Foreign Application Priority Data
Mar. 28, 2018 (DE) 10 2018 107 358.5

(51) Int. Cl. B60G 15/06; B60G 3/14

(52) U.S. Cl. CPC B60G 15/06; B60G 3/14; B60G 2202/30; B60G 2200/44; B60G 2200/132

(57) ABSTRACT

A wheel module for a motor vehicle is provided with a wheel, a steering rod which can be rotatably mounted on a supporting frame of the motor vehicle for transmitting a steering motion to the wheel, a wishbone connected to the steering rod for forming an articulation point radially offset relative to the wheel, a rocker articulated to the articulation point of the wishbone and to the wheel, and a shock absorber connected to the rocker and the wishbone for damping vibration of a relative movement of the wheel. The shock absorber, in particular including a chassis spring, is arranged to be axially offset in the axial direction of the wheel relative to the wheel. With the shock absorber connected to the wheel and the wishbone and arranged next to the wheel, a large steering angle for a motor vehicle is possible with a small installation space.

### CROSS-REFERENCE TO RELATED APPLICATIONS

This application is the U.S. National Phase of PCT Appln. No. PCT/DE2019/100281 filed Mar. 26, 2019, which claims priority to DE 10 2018 107 358.5 filed Mar. 28, 2018, the entire disclosures of which are incorporated by reference herein.

### TECHNICAL FIELD

The disclosure relates to a wheel module for a motor vehicle, with the aid of which the motor vehicle can be steered and/or driven and/or braked and/or damped with the aid of a spring/damper unit.

### BACKGROUND

A motor vehicle with a wheel module is known from CN 206679065 U, in which a wheel of the wheel module can be rotated through 90° about a vertical steering axis in order to be able to park the motor vehicle even in narrow parking spaces.

There is a constant need for a motor vehicle to achieve a large steering angle in a small installation space.

### SUMMARY

It is desirable to develop a wheel module which enables a large steering angle for a motor vehicle in a small installation space.

The is achieved by a wheel module as described herein.

A wheel module for a motor vehicle, in particular a multi-track passenger car, is provided with a wheel for the locomotion of the motor vehicle, a steering rod which can be rotatably mounted on a support frame of the motor vehicle for transmitting a steering motion to the wheel, a wishbone connected to the steering rod for forming an articulation point radially offset to the wheel, a rocker articulated to the articulation point of the wishbone and to the wheel, and a shock absorber connected to the rocker and the wishbone for damping vibration of a relative movement of the wheel, the shock absorber, in particular including a chassis spring, being arranged axially offset to the wheel in the axial direction of the wheel.

To steer the motor vehicle, a torque can be introduced via the steering rod in order to turn the wheel. The torque of the steering rod can be transmitted to the rocker from the wishbone, which is in particular made in one piece with the steering rod. Thus, the joint axes of the rocker at the linkage with the wishbone and at the linkage to the wheel, for example, are essentially aligned tangentially to the wheel, so that the torque of the steering rod is only used to turn the wheel and not to pivot the rocker. Particularly preferred are the joint axes of the rocker being oriented to be tangential to the direction of rotation of the torque, so that the torque of the steering rod can be introduced into the wheel from the wishbone with the largest possible lever arm, which corresponds in particular to the distance between the joint axes of the rocker. For example, the joint axis of the rocker may be in a horizontal plane with the axis of rotation of the wheel, while in particular the steering axis of the steering rod is in a vertical direction.

Since a suspension strut, which can be composed of the shock absorber and/or the suspension spring, is arranged next to the wheel and not above it, this results in a particularly compact and space-saving design. The shock absorber is directly or indirectly connected to the wheel or the rocker at one end and directly or indirectly to the wishbone or the steering rod at the other end. As a result, the shock absorber can be carried along by the wishbone rotated with the steering rod when the wheel is turned. In principle, it is even possible to make the wheel freely rotatable about the steering axis, since the steering angle of the wheel is no longer limited by a possible impact on the shock absorber. A changing extension of the shock absorber during a damping movement can be compensated by a pivoting movement of the rocker on the wishbone. In addition, the wheel module can be attached to the support frame of the motor vehicle via a suspension spring which springs the wheel in the vertical direction. However, it is also possible to integrate the suspension spring into the wheel module by combining the suspension spring, for example, between the shock absorber and between the rocker and the wishbone or damper and suspension spring to form a shock-absorber strut. This opens up freedom of design, which can be used to achieve further savings in installation space. The shock absorber can prevent the wheel from being lifted off the ground when the wheel resiliently gives way when the road is uneven, so that a contact force of the wheel on the ground sufficient for driving safety can be maintained. As a result, a high level of driving comfort can be achieved with a high level of driving safety. The shock absorber connected to the wheel and wishbone and arranged next to the wheel enables a large steering angle for a motor vehicle in a small installation space.

In particular, the steering rod is fitted with a fastening lug projecting in the radial direction of the steering rod, the fastening lug being used to attach the wishbone and/or shock absorber axially offset to the wheel. A sufficient offset can be achieved by the fastening lug in order to be able to connect the shock absorber offset in the axial direction to the wheel. At the same time, it is also possible to connect the wishbone offset to the wheel in the axial direction using the fastening lug. This means that it is not necessary for the wishbone to be radially spaced apart from the wheel. Instead, it is possible for the wishbone to run at least partially next to the wheel, so that when viewed in the axial direction of the wheel, the wheel can at least partially cover the wishbone. As a result, the wishbone can be made shorter and more compact, as a result of which the weight of the wishbone and the material used for producing the wishbone can be reduced. The required installation space and manufacturing costs can thus be reduced.

Preferably a steering head angle a of a steering axis of the steering rod to a horizontal surface is 70°≤α≤95°, particularly 75°≤α≤93°, preferably 80°≤α≤90° and particularly preferably 85°≤α≤88°. Due to the particularly steep alignment of the steering axle, particularly large steering angles can be easily achieved. This enables the driving of particularly tight curves. It is even easily achievable to drive with the motor vehicle not only essentially in longitudinal direction, but even in transverse direction. This makes it possible to park in a particularly narrow parking space without a maneuvering distance in the longitudinal direction.

A steering axis of the steering rod is particularly preferably offset and/or angled to an axis of rotation of the wheel to form a positive caster, in particular the steering axis being arranged completely in front of the axis of rotation in the direction of travel. Particularly in the case of a particularly large steering head angle of a steering axle of the steering rod to a horizontal surface, the steering axle can be located completely in front of the rotation axle in the direction of travel, so that a positive caster can be ensured even with wheels of different sizes and diameters. The positive caster ensures that when the wheel is turned from the straight-ahead position, it experiences a restoring torque that seeks to bring the wheel back into the straight-ahead position. This leads to self-stabilization. In particular, if a sufficiently large torque is not introduced due to a defect, the positive caster can avoid an unstable rotational movement of the wheel.

In particular, an electrically drivable wheel hub drive is provided between the rocker and the wheel, the rocker in particular being axially offset in the axial direction of the wheel relative to the wheel hub drive. The wheel hub drive can be integrated into the wheel and arranged radially within a tire of the wheel so that no additional installation space is required due to the wheel hub drive. The wheel hub drive enables the wheel of the wheel module to be driven separately. In particular, a plurality of wheel modules can be provided for a multi-track passenger car, each of which can be driven individually by the respective wheel hub drive. This enables particularly high flexibility in the direction of travel of the motor vehicle and/or enables a particularly small turning circle. Preferably, the wheel hub drive can also be used to recuperate braking energy to generate electrical energy when the wheel is decelerated.

Preferably the rocker is articulated to the wheel substantially coaxially to an axis of rotation of the wheel, whereby in particular the shock absorber, in particular including the chassis spring, is articulated to the rocker at a distance from the axis of rotation of the wheel via a lever distance. Due to the connection of the shock absorber offset from the axis of rotation of the wheel, a translation or reduction between the movement of the shock absorber and the vertical movement of the wheel can be achieved via the lever distance. This allows the force applied to the wheel by the shock absorber and/or the amount of relative movement of the wheel achieved at this force to be adjusted appropriately. The damping of the wheel with the help of the shock absorber can be done more smoothly and comfortably.

A level control device, in particular one connected at least indirectly to the shock absorber via the suspension spring, for adjusting a vertical relative position of the wheel and/or the suspension spring is particularly preferred, wherein the level control device in particular can be actuated electrically, hydraulically or pneumatically. With the aid of the level control device, an initial position of the wheels can be set relative to the support frame of the motor vehicle. For example, lowering of the vehicle can be achieved by this, whereby the lowering can be reversed for a particularly uneven surface. The level control device can be provided, for example, between the shock absorber and a suspension spring attached to the support frame or between the support frame and the suspension spring. The level control device can be provided, for example, on the lower spring support or on the upper spring support of the suspension spring.

In particular, a steering actuator, in particular a coaxially arranged steering actuator, is connected to the steering rod to initiate a steering motion, the steering actuator in particular having an electric machine for delivering an electrically generated steering torque. The steering actuator is provided in particular only for actuating the wheel of the wheel module, so that preferably each wheel module of the motor vehicle can be actuated individually. The steering actuator can in particular act directly on the steering rod, so that there is a particularly compact and space-saving structure for introducing the steering torque. A mechanical steering linkage can be dispensed.

Preferably the steering rod can be rotated by a steering angle β of at least 135°, particularly 135°≤β≤360°, preferably 180°β≤β≤330° and particularly preferably 270°≤β≤300°. This enables the driving of particularly tight curves. It is even easily achievable to drive with the motor vehicle not only essentially in longitudinal direction, but even in transverse direction. This makes it possible to park in a particularly narrow parking space without a maneuvering distance in the longitudinal direction.

The disclosure also relates to a motor vehicle, in particular a multi-track passenger car, with a support frame, a first wheel module connected to the support frame, which can be developed and further developed as described above, and a second wheel module offset in the transverse direction to the first wheel module, which can be developed and further developed as described above, wherein the first wheel module and the second wheel module can be actuated independently of one another. Preferably, a further pair of wheel modules offset in the longitudinal direction is provided, each of which can be designed and developed as described above. This enables particularly high flexibility in the direction of travel of the motor vehicle and/or enables a particularly small turning circle. The shock absorber of the respective wheel module, which is connected to the wheel and the wishbone and is arranged next to the wheel, allows a large steering angle for a motor vehicle in a small installation space.

### BRIEF DESCRIPTION OF THE DRAWINGS

In the following, the wheel module is explained by way of example with reference to the attached drawings using preferred exemplary embodiments. In the following:

FIG. 1: shows a schematic diagram of a wheel module and

FIG. 2: shows a schematic perspective view of an embodiment of the wheel module from FIG. 1.

### DETAILED DESCRIPTION

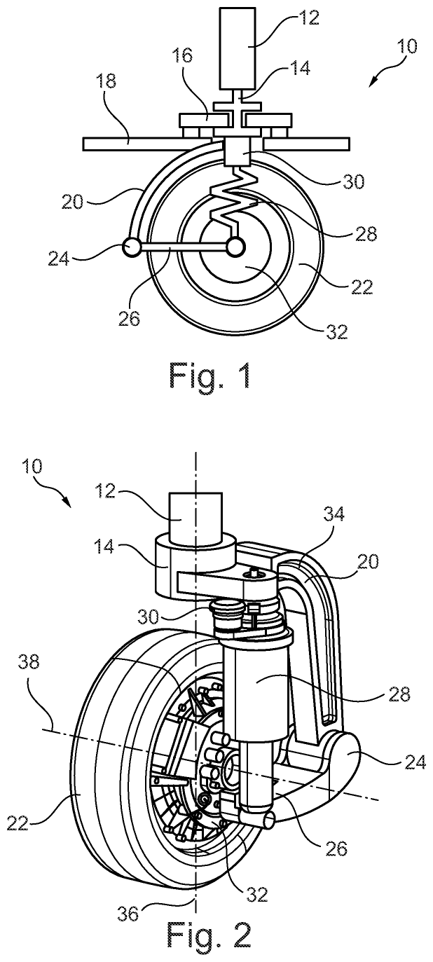

The wheel module 10 shown in FIG. 1 for a motor vehicle designed as a multi-track passenger car has a steering rod 14 which can be rotated by a steering actuator 12. The steering rod 14 can be directly or indirectly rotatably mounted via a steering head bearing 16 on a support frame 18 of the motor vehicle, the steering rod 14 in particular being immovably mounted in the axial direction of the steering rod 14, for example by an axial bearing. A wishbone 20 is attached to the steering rod 14 and forms an articulation point 24 on the horizontal level of an axis of rotation 38 of a wheel 22 of the wheel module 10 to be steered. At the articulation point 24 a rocker 26 is connected to the wheel 22 in a pivoted manner, whereby the rocker 26 is connected at the other end thereof in an articulated and coaxial manner to the wheel 22. A shock absorber 28 is attached to the wheel 22 and/or to the rocker 26 and a suspension spring is attached directly or indirectly to the wheel 22, which is attached at the other end thereof to the steering rod 14 and/or to the wishbone 20. In the exemplary embodiment shown, a level control device 30 is provided between the shock absorber 28 at the upper foot point of the suspension spring and the steering rod 14. The wheel 22 can in particular be driven and/or decelerated by a wheel hub drive 32.

As shown in FIG. 2, a fastening lug 34 can protrude radially from the steering rod 14, which is designed as a hollow shaft, to which the shock absorber 28, the suspension spring and if necessary, also the wishbone 20 is attached. This makes it possible to arrange the shock absorber 28, the suspension spring and/or the wishbone 20 axially next to the wheel 22. A steering axis 36, which in particular is essentially vertical, runs completely in front of the axis of rotation 38 of the wheel 22, so that even with different diameters of the wheel 22, the steering axis 22 runs as a secant through the wheel 22 in front of the axis of rotation 38. This ensures a positive caster for the wheel 22.

When the steering actuator 12 rotates the wheel 22, the shock absorber 28 arranged next to the wheel 22 to save space and the suspension spring can be carried along, so that a steering angle of the steering rod 14 is not limited by the shock absorber 28 or the suspension spring. In principle, the wheel 22 can therefore perform any number of revolutions.

### LIST OF REFERENCE SYMBOLS

Wheel Module
12 Steering Actuator
14 Steering Rod
Steering Head Bearing
18 Support Frame
20 Wishbone
22 Wheel
24 Articulation Point
Rocker
28 Shock Absorbers
30 Level Control Device
32 Wheel Hub Drive
34 Fastening Lug
36 Steering Axle
38 Axis of Rotation

1. A wheel module for a motor vehicle, the wheel module comprising:
a wheel for moving the motor vehicle:
a steering rod rotatably mountable on a support frames of the motor vehicle for transmitting a steering motion to the wheel:
a wishbone connected to the steering rod to form an articulation point radially offset from the wheel:
a rocker articulated to the articulation point of the wishbone and to the wheel; and
a shock absorber connected to the rocker and the wishbone for damping vibrations of a relative movement of the wheel, the shock absorber being arranged axially offset in an axial direction of the wheel from the wheel.

2. The wheel module according to claim 1 wherein a fastening lug projecting in a radial direction of the steering rod is fastened to the steering rod, the wishbone and/or the shock absorber.

3. The wheel module according to claim 1 wherein a steering head angle α of a steering axis of the steering rod to a horizontal base is at least 70° and at most 95°.

4. The wheel module according claim 1 wherein a steering axis of the steering rod is offset and/or angled to an axis of rotation of the wheel to form a positive caster, wherein the steering axis is arranged completely in front of the axis of rotation in direction of travel.

5. The wheel module according to claim 1 further comprising an electrically drivable wheel hub drive between the rocker and the wheel, the rocker being arranged to be axially offset with respect to the wheel hub drive in the axial direction of the wheel.

6. The wheel module according to claim 1 wherein the rocker is connected to the wheel in an articulated manner essentially coaxially to an axis of rotation of the wheel, the shock absorber being connected to the rocker in an articulated manner at a lever distance from the axis of rotation of the wheel.

7. The wheel module according to claim 1 further comprising a level control device, at least indirectly connected to the shock absorber via a suspension spring, for adjusting a vertical relative position of the wheel and/or the suspension spring.

8. The wheel module according to claim 1 further comprising a coaxially arranged steering actuator for initiating a steering motion, connected to the steering rod.

9. The wheel module according to claim 1 wherein the steering rod is rotatable through a steering angle β of at least 135°.

10. A motor vehicle comprising:
a support frame;
a first wheel module according to claim 1 connected to the support frame; and
a second wheel module according to claim 1 offset to the first wheel module in a transverse direction;
wherein the first wheel module and the second wheel module are independently operable.

11. The wheel module according to claim 1 wherein the shock absorber includes a coil spring.

12. The wheel module according to claim 3 wherein the steering head angle α of the steering axis of the steering rod to the horizontal base is at least 75° and at most 93°, preferably 80°≤α≤90° and particularly preferably 85°≤α≤88°.

13. The wheel module according to claim 3 wherein the steering head angle α of the steering axis of the steering rod to the horizontal base is at least 80° and at most 90°.

14. The wheel module according to claim 3 wherein the steering head angle α of the steering axis of the steering rod to the horizontal base is at least 85° and at most 88°.

15. The wheel module according to claim 7 wherein the level control device is actuated electrically.

16. The wheel module according to claim 7 wherein the level control device is actuated hydraulically.

17. The wheel module according to claim 7 wherein the level control device is actuated pneumatically.

18. The wheel module according to claim 8 wherein the steering actuator is an electric machine.

19. The wheel module according to claim 9 wherein the steering angle β is at least 180° and at most 330°.

20. The wheel module according to claim 9 the steering angle β is at least 270° and at most 300°.
